(19) United States
(12) Patent Application Publication
(10) Pub. No.: US 2006/0190470 A1
(43) Pub. Date: Aug. 24, 2006

(54) DOWNLOAD, STORAGE, AND RETRIEVAL DEVICE

(76) Inventor: Peter A. Lemnotis, Plantsville, CT (US)

Correspondence Address: DOHERTY, WALLACE, PILLSBURY & MURPHY, P.C., ONE MONARCH PLACE, SUITE 1900, 1414 MAIN STREET, SPRINGFIELD, MA, 01144-1900, US

(21) Appl. No.: 11/307,696

(22) Filed: Feb. 17, 2006

Related U.S. Application Data
(60) Provisional application No. 60/593,850, filed on Feb. 18, 2005.

(51) Int. Cl. G06F 7/00; G06F 17/00

(52) U.S. Cl. 707/101

(57) ABSTRACT

A self-contained inventive device capable of downloading and storing data from a personal information manager. The inventive device further comprises a feature that allows the data to be uploaded to either the same personal information manager from which the data was downloaded or to an entirely different personal information manager, wherein the different personal information manager may or may not be compatible with the original personal information manager. Furthermore, the inventive device comprises an operator input element whereby a user may input data directly into the inventive device. Such input data may then be uploaded to a personal information manager. Additionally, individual datum may be selectively removed from the inventive device such that that particular datum will not be uploaded to a personal information manager.

### CROSS REFERENCE TO RELATED APPLICATIONS

This application claims the benefit of U.S. Provisional Application No. 60/593,850 filed on Feb. 18, 2005.

### BACKGROUND OF THE INVENTION

1. Field of the Invention

This invention relates to an inventive device that can download, store, and upload data. More particularly, this invention relates to a self-contained inventive device that selectively downloads and stores information from a personal information manager, and selectively uploads the data either to the same or to a different personal information manager.

2. Background of the Invention

Personal information managers can be programmed to store a variety of data. Such data includes without limitation, for example, street addresses, e-mail addresses, pager addresses, home telephone numbers, office telephone numbers, and other telephone numbers, fax telephone numbers, company information, and other contact information. Oftentimes it is desirable to transfer the data from one personal information manager to another, such as, for example, when a new wireless phone is purchased. Additionally, in the situation where a programmed wireless phone is lost or stolen, ideally the data could be stored in a backup system such that the data could be easily transferred from the personal information manager to a new wireless phone. This easy conveyance of data from one wireless phone to another, of course, would obviate the need to manually enter the data into the non-programmed wireless phone, a process that is tedious and time consuming.

Although the prior art indicates that a computer based system consisting of access to databases or the Internet may be utilized to download, store, and upload data from one source to another, such a system is costly, requires multiple components, requires compatibility among the various components, is complicated in design and in execution, is cumbersome, requires user sophistication, and is vulnerable to exploitation by third parties. Accordingly, what is needed is a self-contained inventive device that can selectively download, store, and upload encrypted data contained in a personal information manager without relying on components separate and apart from the inventive device. Additionally, the inventive device should be easy to use, and should allow for the selective downloading, storing, and uploading of data such that redundant or outdated data is not transferred from or to a personal information manager. Furthermore, what is needed is an inventive device capable of downloading data from and uploading data to both compatible and incompatible personal information managers. Also what is needed is an inventive device that will securely download, store, and upload the data without interference by unauthorized third parties.

### SUMMARY OF THE INVENTION

The above-discussed and other drawbacks and deficiencies of the prior art are overcome or alleviated by a self-contained inventive device capable of downloading and storing data from a personal information manager. The inventive device further comprises a feature that allows the data to be uploaded to either the same personal information manager from which the data was downloaded or to an entirely different personal information manager, wherein the different personal information manager may or may not be compatible with the original personal information manager. Furthermore, the inventive device comprises an operator input element whereby a user may input data directly into the inventive device. Such input data may then be uploaded to a personal information manager. Additionally, individual datum may be selectively removed from the inventive device such that that particular datum will not be uploaded to a personal information manager.

### BRIEF DESCRIPTION OF THE DRAWINGS

FIG. 1 is a schematic depicting an exemplary storage and retrieval inventive device; and

FIG. 2 is a schematic depicting an exemplary storage and retrieval inventive device and personal information manager.

### DETAILED DESCRIPTION OF THE INVENTION

The storage and retrieval inventive device of the present invention is capable of downloading, storing, and uploading data contained in a personal information manager (“PIM”). As used herein and throughout, PIMs include, but are not limited to, integrated radio transmitter-receivers capable of accessing a vast web of existing telephone connections and includes cellular phones. The data may include any datum that is typically stored in a PIM, and includes without limitation phone numbers, identification numbers, e-mail addresses, street addresses, calendars, personal reminders, and the like.

In application, data from any PIM may be downloaded from the PIM and stored in the inventive device. The data may then be transferred from the inventive device to another PIM by downloading the data from the inventive device. Additionally, data may be entered directly into the inventive device by an operator input element, wherein such data entry may be accomplished by typing in the data, orally recording the data, and the like. Such newly entered data may be stored on the inventive device and uploaded from the inventive device to a PIM. Furthermore, undesired, outdated, or duplicative data may be selectively erased from the inventive device such that the selected data will not be available for uploading to the PIM.

In the following detailed description, numerous specific details are set forth in order to provide a thorough understanding of the present invention. However, it will be understood by those skilled in the art that the present invention may be practiced without these specific details and that the present invention may be practiced in a variety of alternate embodiments. In other instances, well known methods, procedures, components, and circuits have not been described in detail.

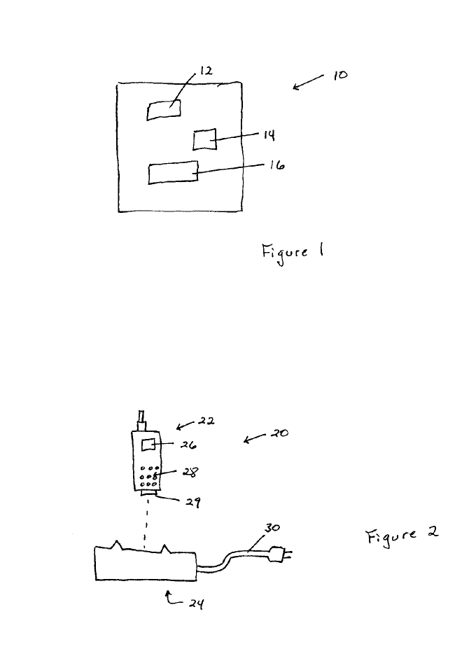

FIG. 1 depicts an exemplary download, storage, and retrieval inventive device. Referring to FIG. 1, inventive device 10 comprises a port 12 for connecting inventive device 10 to a wireless phone. Inventive device 10 further comprises an operator input element 14 that may include an alphanumeric keyboard. Operator input element 14 allows a user to enter any additional data that can be uploaded into a wireless phone. Inventive device 10 further comprises a display 16. Display 16 provides a site whereby the data contained in inventive device 10 can be viewed by a user. The user may scroll through the data via operator input element 14.

FIG. 2 is an external view of a processing system according to an embodiment of the present invention. In FIG. 2, a processing system 20 includes a wireless phone 22, and an inventive downloading, storing, and uploading device 24. One of the main surfaces of a housing of the wireless phone 22 is provided with a liquid crystalline display 26 and an operation part 28. Operation part 28 includes a plurality of keys actuated by a user. Wireless phone 22 further comprises a connector or a contact 29 provided on the bottom of the housing of wireless phone 22. When wireless phone 22 is attached to downloading, storing, and uploading device 24, connector 29 electrically connects internal circuits of wireless phone 22 and downloading, storing, and uploading device 24. Data can also be synchronized from the inventive device to a PIM though bluetooth, other 802.x and wireless protocols. A housing of downloading, storing, and uploading device 24 is provided with a plug 30 for connection to a commercial power source, although it is contemplated herein that downloading, storing, and uploading device 24 may run on batteries.

The inventive device is completely self-contained and comprises its own central processing unit (“CPU”) and operating system (“OS”), making it functionally independent. Software running on the OS does the work of data management in the Basic Input/Output System (“BIOS”). PIM data can be stored on the inventive devices memory such as, for example, a read only memory (“ROM”), or on an external memory card.

To operate the inventive device, a user interface (“UI”) is provided on the hardware device. Hardware/software controls are preferably self-contained and present on the inventive device. These controls manage access to the inventive device and the data stored on the inventive device. However, it is contemplated that there may be other means to manage the inventive device. Other forms of management include a UI from the PIM, through a web browser, or as applets and applications, as an alternative to but not a replacement for the controls found on the inventive device itself. The UI provides the user with the ability to establish a secure link between the unit and the PIM(s). Multiple links allow for more than one PIM. When the link is established, data can be managed on both the inventive device and the PIM, with the ability to traffic data between the two. The UI also allows for the management of all data, including the ability to add, edit, delete, and secure access to the data.

In an exemplary embodiment, in order for a PIM to update or backup the information, a secure connection though a security code is established for each PIM. Additionally, preferably there is also global data which may be propagated without a security connection.

The inventive device of the present invention, therefore, comprises a self-contained stand-alone unit, which can store PIM data in a secure environment. The size of the inventive device is preferably portable, and is not limited to any size dimensions. The inventive device obviates the security necessary when storing data by means of a personal computer, laptop, or the internet, e.g., storing an address book on the Internet, could expose it to the possible resale of the data in the address book to outside marketers. In the event that the PIM becomes lost, stolen or damaged, the inventive device of the present invention allows for the placement of a replacement PIM onto the inventive device and allows for the upload of all of the previously stored data. This operation, then, updates the replacement PIM with the identical data that was in the original PIM.

The inventive device further enables a user, via use of the PIM interface (e.g., a wireless phone's key pad or the inventive device's operator input element), to download and upload the user's personal address book without risk of any exposure to the outside business world. The inventive device can accommodate all types, brands, and models of PIMs by using adapters which are compatible with the inventive device. Furthermore, the inventive device may comprise a display and more advanced programming to allow a user to scroll and preview the data on the display. The above inventive device is unique, therefore, because, among other things, it provides the user with the capability of storing data privately, and with the capability of restoring all of the data in the event that the information is lost.

As required, detailed embodiments of the present invention have been disclosed herein. However, it is to be understood that the disclosed embodiments are merely exemplary of the invention, which may be embodied in various forms. Therefore, specific structural and functional details disclosed herein are not to be interpreted as limiting, but merely as a representative basis for teaching one skilled in the art to variously employ the present invention in virtually any appropriately detailed structure.

The foregoing disclosure of the preferred embodiments of the present invention has been presented for purposes of illustration and description. It is not intended to be exhaustive or to limit the invention to the precise forms disclosed. Many variations and modifications of the embodiments described herein will be obvious to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particularly sequence of steps. However, to the extent that the method of process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A method for handling data comprising:
inputting data into a device;
indefinitely storing the data on the device;
selecting the data to be transferred to a first personal information manager; and
uploading and transferring the selected data from the device to a first personal information manager, wherein the device is a self-contained unit comprising:
a central processing unit in communication with an operating system, and software and hardware specifically designed to receive, store, and upload data to a variety of the same or different personal information managers.

2. The method of claim 1, wherein selecting the data is accomplished by a user interface located on the device.

3. The method of claim 1, wherein inputting data into the device comprises downloading the data from a second personal information manger.

4. The method of claim 1, wherein inputting data into the device comprises use of an operator input element located on the device.

5. The method of claim 1, wherein indefinitely storing the data on the device includes storing the data in a read only memory located on the device or on a memory card readable by the device.

6. The method of claim 1, further comprising editing or otherwise modifying the data prior to uploading the data.

7. The method of claim 6, wherein the editing occurs via a user interface located on the device.

8. The method of claim 6, wherein the editing occurs via an operator input element located on the device.

9. The method of claim 1, further comprising securing the transfer of data to and from the device as accomplished by software and/or hardware located on the device.

10. A method for handling data comprising:
inputting data into a device;
indefinitely storing the data on the device; and
uploading the data from the device to a first personal information manager, wherein the device comprises:
a means for downloading data from a first personal information manager;
a means for storing the data on the device; and
a means for uploading the data from the device and storing the data on the first personal information manager or on a second personal information manager.

11. The method of claim 10, wherein the device further comprise a means for securing the transfer of data from the first personal information manager to the device and from the device to the second personal manager.
